(19) United States
(12) Patent Application Publication
(10) Pub. No.: US 2009/0269970 A1
(43) Pub. Date: Oct. 29, 2009

(54) TERMINAL CRIMPING STRUCTURE

(75) Inventor: Hideto KUMAKURA, Shizuoka (JP)

Correspondence Address: SUGHRUE-265550, 2100 PENNSYLVANIA AVE. NW, WASHINGTON, DC, 20037-3213, US

(73) Assignee: YAZAKI CORPORATION, Tokyo (JP)

(21) Appl. No.: 12/389,018

(22) Filed: Feb. 19, 2009

(30) Foreign Application Priority Data
Apr. 23, 2008 (JP) 2008-112493

(51) Int. Cl. H01R 11/20

(52) U.S. Cl. 439/421

(57) ABSTRACT

A terminal crimping structure includes a terminal connection portion which connects an insulation-coated electric wire having a core wire covered with an insulation coating portion. The terminal connection portion has a first crimping member and a second crimping member. The first crimping member crimps a folded-back portion formed by folding back the core wire exposed from the insulation coating portion. The second crimping member crimps both of the insulation coating portion and an end of the folded-back portion which is superposed on the insulation coating portion.

### BACKGROUND

The present invention relates to a terminal crimping structure for electrically connecting a terminal and an electric wire by crimping and, more particularly, to a terminal crimping structure suitable for a thin aluminum wire whose mechanical strength is low.

For example, a wire harness wired in an automobile uses an electric connector constituted by connector housings fit to each other and by a plurality of crimping terminals that are inserted and fit to these connector housings and that are crimpedly connected to electric wires of wire harnesses.

It is requested for weight reduction to use aluminum wires as electric wires of wire harnesses. However, aluminum wires have such characteristics that the mechanical strength and the fusing temperature thereof are low, and that each stranded wire constituting electric wires is liable to form an oxide layer thereon. Thus, electric current is likely to flow only in specific strand wires. Consequently, constriction resistance is easily generated therein. Accordingly, there is a fear of occurrence of fusion and electrical conduction failure.

Thus, when the aluminum wire is crimped so strongly that each strand wire and the crimping member are extremely closely attached to each other to break down the oxide layer formed on each strand wire, electrical conduction characteristics can be sufficiently enhanced. However, an electric wire holding force is reduced due to large stress acting upon a wire crimping portion, so that necessary crimping strength cannot be obtained. On the other hand, when a compression ratio is reduced to obtain a sufficiently strong electric wire holding force, the conventional terminal crimping structure has encountered problems that the oxide layer formed on each strand wire cannot be broken down, and that increase in contact resistance occurs in an environmental test, such as a temperature cycle test, so that the electrical conduction characteristics are insufficient.

In order to cope with such a problem, according to a technique described in, e.g., Patent Document 1, in a structure in which a core wire exposed from an insulation-coated electric wire is crimped by a first crimping member, and in which an insulation-coated part of the electric wire is crimped by a second crimping member, the first crimping member is divided into two parts. Then, a terminal-side part of the crimping member is crimped at a large compression ratio, while the other part thereof, which is positioned further distantly from the terminal, is crimped at a small compression ratio. According to this document, the problem of reduction in the electric wire holding force due to an excessively large compression ratio, at which the aluminum wire is crimped, and that of conduction failure due to an insufficient compression ratio can be solved at once.

However, according to the technique described in Patent Document 1, the compression ratios respectively corresponding to the two crimping member parts, into which the first crimping member is divided, are differentiated from each other. Thus, a stepped crimping jig is necessary. Accordingly, the technique described in Patent Document 1 has a problem in that a crimping die is complex. In addition, because the core wire is crimped at crimping ratios changed in a stepwise manner, it is necessary to manage the height of the first crimping member, which corresponds to each compression ratio and is obtained after crimping. Consequently, the technique described in Patent Document 1 has another problem in that this requirement results in increase in the cost thereof.

On the other hand, in order to reduce and stabilize electric resistance without using the stepped crimping jig, it has been proposed that the core wire is folded back and is then crimped by the first crimping member (see, e.g., Patent Document 2). Consequently the contact area between the crimping member and the folded-back portion of the core wire is increased. Accordingly, the electric resistance can be reduced and stabilized.

[Patent Document 1] JP-A-2005-50736

[Patent Document 2] JP-A-2005-302476

However, it is requested to further increase the fixing force of the electric wire connection portion.

### SUMMARY

A problem to be solved by the invention is to increase the fixing force for fixing an electric wire in an electric wire connection portion of a terminal crimping structure.

In order to solve the aforementioned problem, according to the invention, there is provided a terminal crimping structure, comprising:

a terminal connection portion which connects an insulation-coated electric wire having a core wire covered with an insulation coating portion,

wherein the terminal connection portion has a first crimping member and a second crimping member;

wherein the first crimping member crimps a folded-back portion formed by folding back the core wire exposed from the insulation coating portion; and

wherein the second crimping member crimps both of the insulation coating portion and an end of the folded-back portion which is superposed on the insulation coating portion.

Thus, the folded-back portion formed by folding back the core wire is crimped by the first crimping member. Consequently, the contact area between the core wire and the crimping member can be increased. Accordingly, the fixing force of the electric wire connection portion can be increased. In addition, the electric resistance thereof can be reduced and stabilized.

Further, an end of the folded-back portion is arranged to be superposed on the insulation coating portion of the electric wire. Both the core wire and the insulation coating portion are crimped together by the second crimping member. Consequently, the fixing force of the electric wire connection portion can be further increased. In addition, the electric resistance thereof can be further reduced and stabilized.

In this case, aluminum can be used as the material of the core wire of the electric wire.

Preferably, each of the first crimping member and the second crimping member has a pair of opposed protruding pieces which are erected from both side edge parts of the terminal connection portion. Consequently, the pairs of opposed protruding pieces can be used as the first crimping member and the second crimping member, respectively.

According to the invention, the fixing force for fixing an electric wire in an electric wire connection portion can be enhanced in the terminal crimping structure.

### BRIEF DESCRIPTION OF THE DRAWINGS

The above objects and advantages of the present invention will become more apparent by describing in detail preferred exemplary embodiments thereof with reference to the accompanying drawings, wherein:

FIG. 1 is a top view illustrating a terminal crimping structure portion;

FIG. 2 is a side view illustrating the terminal crimping structure portion shown in FIG. 1;

FIG. 3 is an exploded view illustrating a terminal and electric wires used in the terminal crimping structure portion;

FIG. 4 is a cross-sectional view taken on line A-A shown in FIG. 3;

FIG. 5 is a graph illustrating the relationship among the height of a crimping member, the resistance value, and the fixing force of an embodiment after crimping;

FIG. 6 is a graph illustrating the relationship among the height of a crimping member, the resistance value, and the fixing force of a comparative example after crimping; and

FIG. 7 is a graph illustrating a temperature pattern in a thermal shock test.

### DETAILED DESCRIPTION OF EXEMPLARY EMBODIMENTS

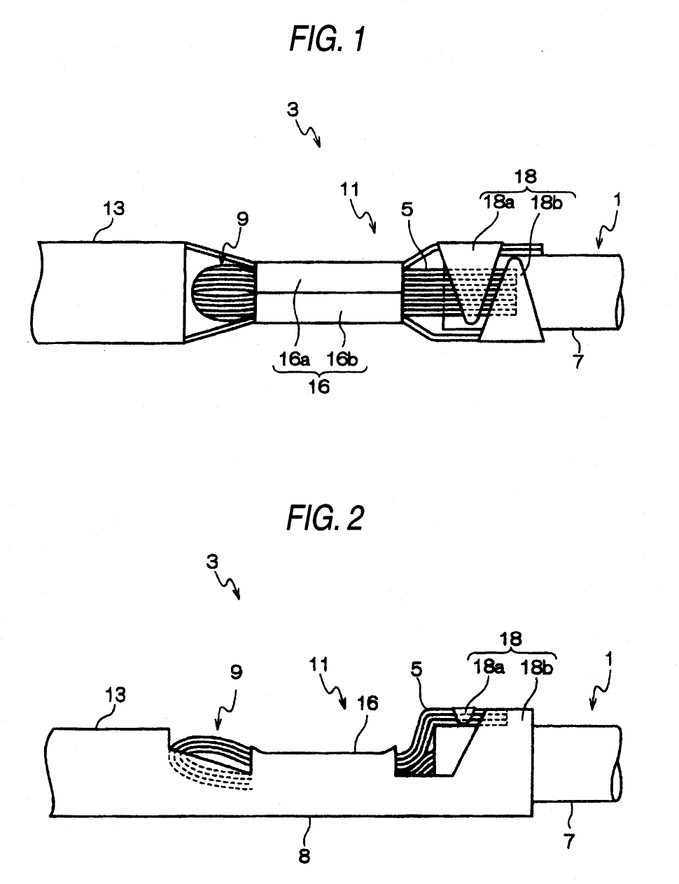

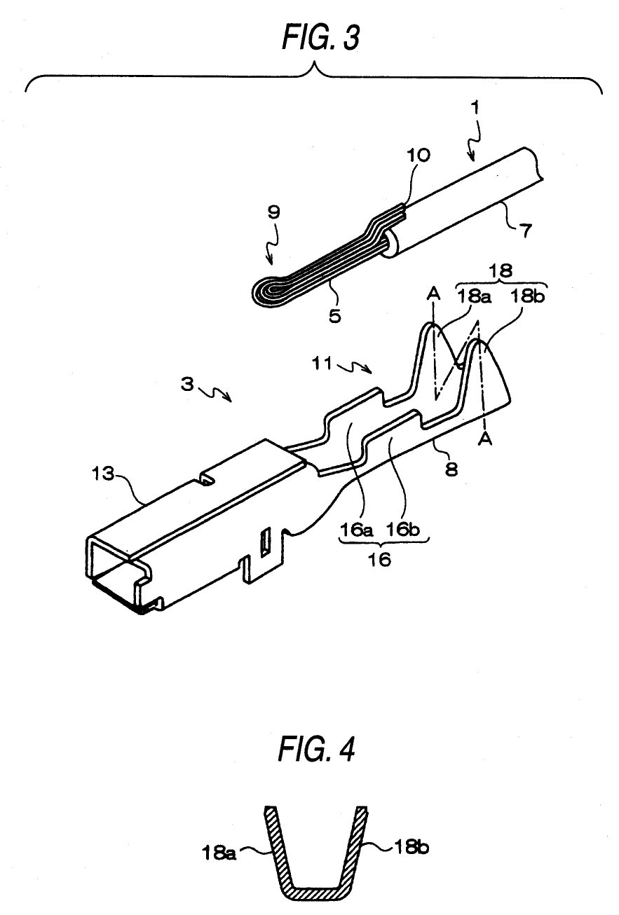

Hereinafter, the invention is described with reference to an embodiment thereof. FIG. 1 is a top view illustrating a terminal crimping structure portion. FIG. 2 is a side view illustrating the terminal crimping structure portion shown in FIG. 1. FIG. 3 is an exploded view illustrating a terminal and electric wires used in the terminal crimping structure portion. FIG. 4 is a cross-sectional view taken on line A-A shown in FIG. 3.

As illustrated in FIG. 3, a terminal 3 according to the present embodiment includes a terminal connection portion 13, to which a mating terminal (not shown) is connected, at one end thereof and an electric wire connection portion 11, which is provided continuously to the terminal connection portion 13, at the other end thereof. The electric wire connection portion 11 includes a strip-like member 8, a wire barrel 16 serving as the first crimping member formed on the strip-like member 8, and an insulation barrel 18 serving as the second crimping member.

The wire barrel 16 includes a pair of opposed projecting pieces 16a and 16b formed by folding back both side edge parts of the strip-like member 8. The wire barrel 16 is formed by being cross-sectionally U-shaped so as to be able to accommodate a folded-back portion 9 of a core line.

The insulation barrel 18 includes a pair of opposed projecting pieces 18a and 18b formed by folding back both side edge parts of the strip-like member 8. Each of the pair of projecting pieces 18a and 18b is formed into a substantially triangular shape. The projecting pieces 18a and 18b are arranged by shifting the positions thereof from each other in the longitudinal direction of the strip-like member 8. As illustrated in FIG. 4, the insulation barrel 18 is formed by being cross-sectionally U-shaped so as to be able to accommodate an insulation coating portion 7.

An electric wire 1 according to the present embodiment is formed by covering a core wire 5 with an insulation coating portion 7. The core wire 5 is made of aluminum. Regarding the insulation coating portion 7, e.g., a polyethylene or polyvinyl-chloride insulation coating portion 7 having elasticity is used. An end of the electric wire 1 is formed by exposing a part of the core wire 5 from the insulation coating portion 7. The exposed part of the core wire 5 is folded back to thereby form a folded-back portion 9. An end portion 10 of the folded-back part of the core wire 5 is arranged by being superposed onto the insulation coating portion 7 of the electric wire 1.

Next, a terminal crimping structure, which is a feature according to the present embodiment of the invention, is described below with reference to FIGS. 1 and 2. The folded-back portion 9 is inserted into between the projecting pieces 16a and 16b. Then, the folded-back portion 9 is crimped by a crimping jig (not shown) so that the distal ends of the projecting pieces 16a and 16b come close to each other. The insulation coating portion 7 in a state, in which the core wire 5 is superposed thereon, is inserted into between the projection pieces 18a and 18. Then, the projecting pieces 18a and 18b are crimped by a crimping jig (not shown). Thus, the core wire 5 is crimped together with the insulation coating portion 7.

Thus, the folded-back portion 9 is crimped by the wire barrel 16. The insulation coating portion 7 and the core wire 5 are crimped by the insulation barrel 18. Consequently, the terminal crimping structure is formed.

Accordingly, the folded-back portion 9 formed by folding back the core wire 5 is crimped by the wire barrel 16. Consequently, the contact area between the core wire 5 and the wire barrel 16 can be increased. The fixing force for fixing the electric wire 1 in the electric wire connection portion 11 can be increased. In addition, the electric resistance can be reduced and stabilized.

Further, the end 10 of the folded-back core wire 5 is arranged by being superposed on the insulation coating portion 7. Both of the core wire 5 and the insulation coating portion 7 are crimped by the insulation barrel 18. Thus, the fixing force of the electric wire connection portion 11 can be further increased. In addition, the electric resistance can be further reduced and stabilized.

### EXAMPLE

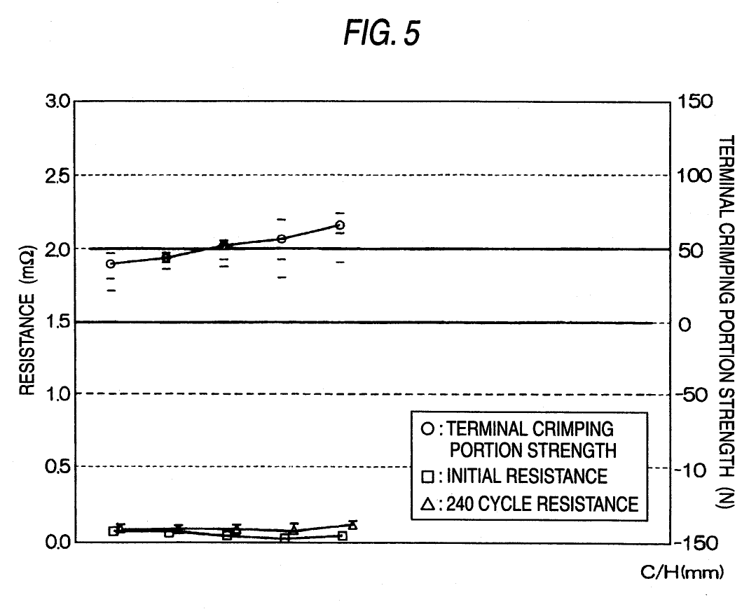

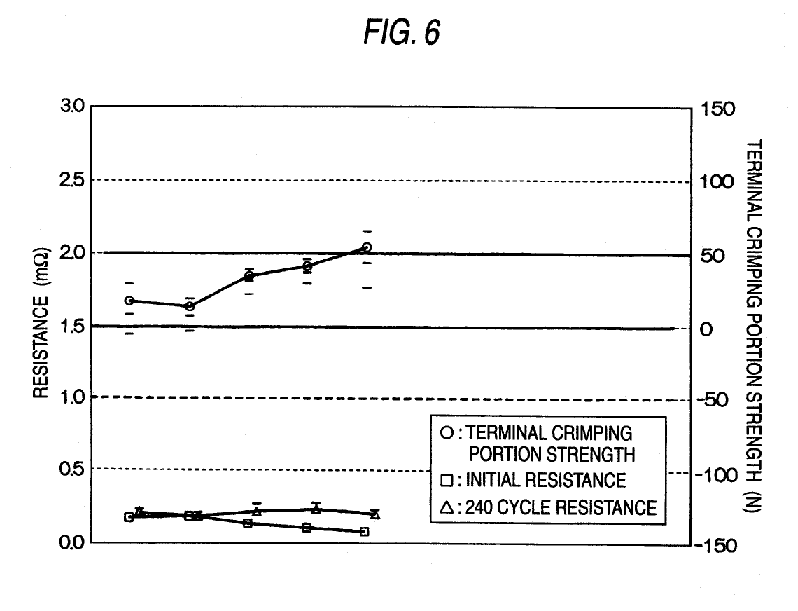

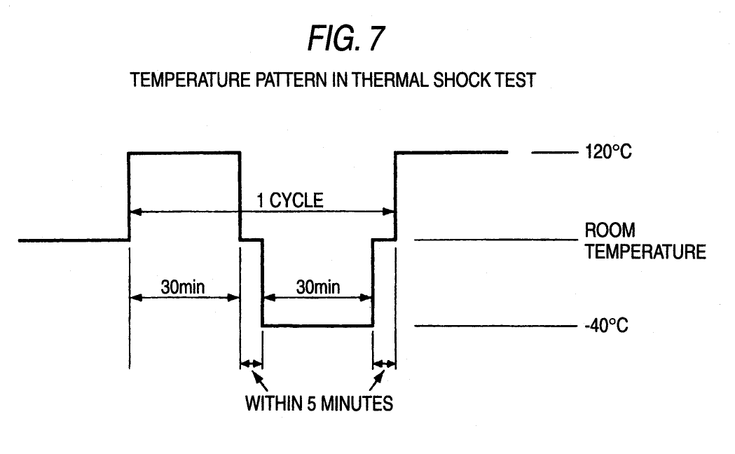

Referring now to FIGS. 5 and 6, there is shown the relationship among the height (C/H) of the wire barrel 16 after crimping the core wire 5, and the resistance value and the fixing force of an example of the embodiment after crimping. FIG. 5 illustrates such relationship in the case of the example of the present embodiment using the aluminum core wire 5 that had a cross-section area of 75 mm². FIG. 6 illustrates such relationship in the case of a comparative example using an aluminum core wire 5 that had a cross-section area of 75 mm² and that was crimped without being folded back. Incidentally, in FIGS. 5 and 6, white circles ◯ represent the fixing force of the electric wire connection portion 11 (i.e., the strength of the terminal crimping portion). White triangles Δ represent the resistance values (240 cycle resistance values) of the example and the comparative example after a thermal shock test. White squares □ represent the resistance values (initial resistance values) of the example and the comparative example in a case where no thermal shock test was performed. Incidentally, the thermal shock test was conducted according to a temperature pattern illustrated in FIG. 7. That is, the example and the comparative example were left 30 minutes in atmosphere having a temperature of 120° C. Then, the example and the comparative example were left 5 minutes at room temperature. Subsequently, the example and the comparative example were left 30 minutes in atmosphere having a temperature of −40° C. Then, the example and the comparative example were left 5 minutes at room temperature. With the above process as one cycle, 240 cycles were carried out.

As is seen from these graphs, in any case of the height (C/H) after crimping, the example according to the present embodiment was less than the comparative example in the resistance value. Thus, the example according to the present embodiment was stabilized, as compared with the comparative example. This was because of the facts that the cross-section area of the core wire 5 inserted in the wire barrel 16 was doubled by folding back and crimping the core wire 5 and that the contact area between the wire barrel 16 and the core wire 5 was increased.

Further, as is seen from these graphs, in any case of the height (C/H) after crimping, the fixing force of the electric wire connection portion 11 of the example according to the present embodiment was larger than that of the electric wire connection portion of the comparative example. Thus, in the case of the example according to the present embodiment, the level of the fixing force was raised as a whole. This was because of the facts that the core wire 5 was crimped by the insulation barrel 18, that thus, the core wire 5 could be securely crimped, and that the fixing force of the electric wire connection portion 11 was maintained.

When an insulation coating portion having elasticity is used as the insulation coating portion 7 of the electric wire 1 used according to the aforementioned present embodiment, the core wire 5 can be more securely crimped by the elastic force and the restoring force of the insulation coating portion 7, in addition to the crimping by the insulation barrel 18.

Further, in the aforementioned present embodiment, the folded-back portion 9 is crimped only by the pair of projecting pieces 16a and 16b of the wire barrel 16. However, the first crimping member according to the invention is not limited thereto. A plurality of pairs of projecting pieces of wire barrels 16 can be provided in the structure. Then, the folded-back portion 9 can be crimped by the plurality of pairs of projecting pieces of wire barrels 16.

Further, although it has been described that the core wire 5 of the electric wire 1 used in the aforementioned embodiment is made of aluminum, the material of the core wire 5 according to the invention is not limited thereto. A core wire made of copper can be used.

Additionally, the projecting pieces 18a and 18b of the insulation barrel 18 according to the aforementioned present embodiment are placed by shifting the positions thereof from each other in the longitudinal direction of the strip-like member 8. However, the projecting pieces 18a and 18b of the insulation barrel 18 can be placed by being opposed to each other at the same position in the longitudinal direction of the strip-like member 8.

Although the invention has been illustrated and described for the particular preferred embodiments, it is apparent to a person skilled in the art that various changes and modifications can be made on the basis of the teachings of the invention. It is apparent that such changes and modifications are within the spirit, scope, and intention of the invention as defined by the appended claims.

The present application is based on Japanese Patent Application No. 2008-112493 filed on Apr. 23, 2008, the contents of which are incorporated herein for reference.

What is claimed is:

1. A terminal crimping structure, comprising:
a terminal connection portion which connects an insulation-coated electric wire having a core wire covered with an insulation coating portion,
wherein the terminal connection portion has a first crimping member and a second crimping member;
wherein the first crimping member crimps a folded-back portion formed by folding back the core wire exposed from the insulation coating portion; and
wherein the second crimping member crimps both of the insulation coating portion and an end of the folded-back portion which is superposed on the insulation coating portion.

2. The terminal crimping structure according to claim 1, wherein each of the first crimping member and the second crimping member has a pair of opposed protruding pieces which are erected from both side edge parts of the terminal connection portion.

3. The terminal crimping structure according to claim 1, wherein the core wire of the electric wire is comprised of aluminum.
